(19) United States
(12) Patent Application Publication
(10) Pub. No.: US 2026/0300781 A1
(43) Pub. Date: Oct. 1, 2026

(54) DISTRIBUTED GENERATION OF INFERENCES USING HOSTED MACHINE LEARNING MODELS

(71) Applicant: INTERNATIONAL BUSINESS MACHINES CORPORATION, Armonk, NY (US)

(72) Inventors: Zhan Peng Huo, Beijing (CN); Xiao Xuan Fu, Wuhan (CN); Yi Dai, Beijing (CN); Sheng Shuang Li, Beijing (CN); Lu Yan Li, Shi Jia Zhuang (CN); Yan Fei Qin, Beijing (CN)

(21) Appl. No.: 19/091,338

(22) Filed: Mar. 26, 2025

(51) Int. Cl. G06N 5/043; G06N 20/00

(52) U.S. Cl. CPC G06N 5/043; G06N 20/00

(57) ABSTRACT

Systems, methods, and computer program products for distributed generation of inferences using hosted machine learning models are disclosed. A method may comprise fetching, from a remote server, a first checklist comprising one or more pre-processing steps and a second checklist comprising one or more post-processing steps; performing the one or more pre-processing steps at a client on an input dataset to generate a pre-processed input dataset; transmitting, from the client to the remote server, the pre-processed input dataset to be processed by the machine learning model; receiving, at the client from the remote server, an output dataset; performing the one or more post-processing steps at the client on the output dataset to generate a post-processed output dataset; and presenting the post-processed output dataset via a client computing platform at the client..

### BACKGROUND

Embodiments of the present disclosure relate to machine learning models, and more specifically, to distributed generation of inferences using hosted machine learning models.

### BRIEF SUMMARY

According to embodiments of the present disclosure, systems, methods of, and computer program products for distributed generation of inferences using hosted machine learning models are disclosed. According to one or more embodiments, a first checklist for pre-processing input data for a machine learning model and a second checklist for post-processing output data from the machine learning model are fetched. The first and second checklists may be fetched at a client. The first and second checklists may be fetched from a remote server hosting the machine learning model. The first checklist may identify one or more pre-processing steps. The second checklist may comprise one or more post-processing steps. The one or more pre-processing steps may be performed to generate a pre-processed input dataset. The one or more pre-processing steps may be performed at the client on an input dataset. The pre-processed input dataset may be transmitted to the remote server to be processed by the machine learning model. The pre-processed input dataset may be transmitted from the client.

An output dataset may be received at the client from the remote server. The one or more post-processing steps may be performed on the output dataset to generate a post-processed output dataset. The one or more post-processing steps may be performed at the client. The post-processed output dataset may be presented via a client computing platform at the client.

### BRIEF DESCRIPTION OF THE DRAWINGS

FIG. 1 is a flow diagram depicting an exemplary method of distributed generation of inferences using hosted machine learning models, in accordance with one or more embodiments of this disclosure.

FIG. 2 is a flow diagram depicting an exemplary method of distributed generation of inferences using hosted machine learning models, in accordance with one or more embodiments of this disclosure.

FIG. 3 is a schematic diagram depicting a system for distributed generation of inferences using hosted machine learning models, in accordance with one or more embodiments of this disclosure.

FIG. 4 depicts a computing node according to one or more embodiments of the present disclosure.

### DETAILED DESCRIPTION

Artificial intelligence models are mostly trained with the processed input data. For this reason, input data must be prepared in a specific format in order to call a trained model. However, it may not be easy to pre-process the input data as required to provide the input data as input to the trained model. Methods for pre-processing input data and post-processing output data have a key bottleneck that influences the model’s inference efficiency and performance. This may be because the deployed data processing and model inference service are both performed on the server side. All pipeline functions from various users being executed on the server side may overly burden the server. Accordingly, users may experience latency issues due to the server being busy handling multiple requests. Various embodiments described herein comprise distributing the efficiently distributing pre-processing and post-processing tasks between the server side and the client side.

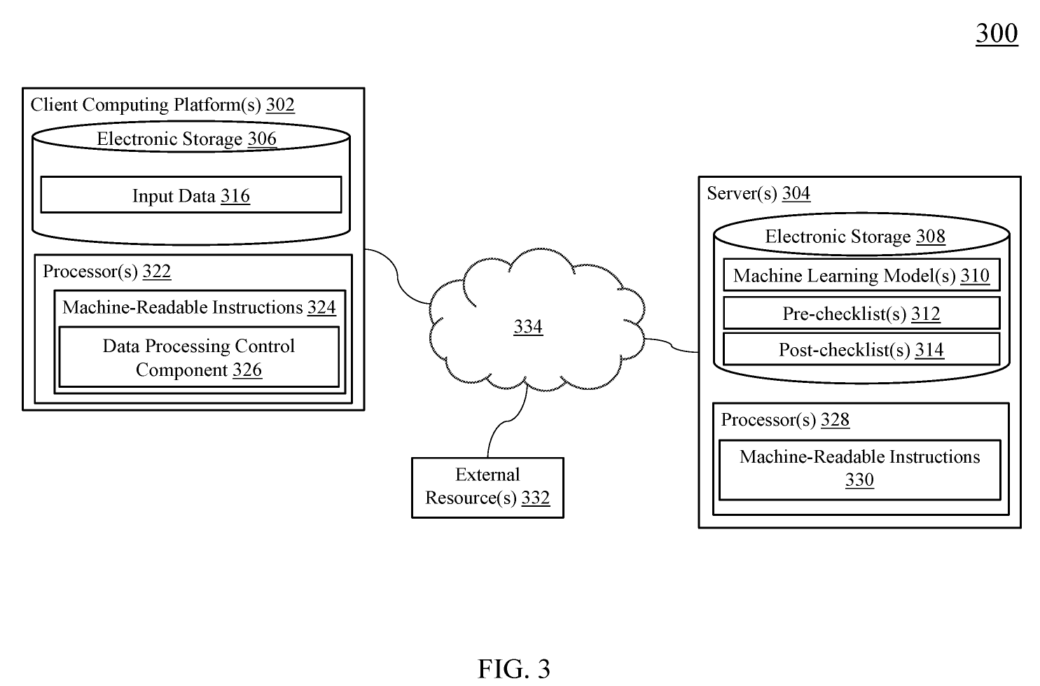

Referring now to FIG. 3, a schematic diagram illustrating a system for distributed generation of inferences using hosted machine learning models is depicted in accordance with one or more embodiments of the present disclosure. System 300 may include one or more servers 304. Server(s) 304 may be configured to communicate with one or more client computing platforms 302 according to a client/server architecture and/or other architectures. Client computing platform(s) 302 may be configured to communicate with other client computing platforms via server(s) 304 and/or according to a peer-to-peer architecture and/or other architectures. Users may access system 300 via client computing platform(s) 302. By way of non-limiting example, a given client computing platform 302 may comprise one or more of a desktop computer, a laptop computer, a handheld computer, a tablet computing platform, a NetBook, a Smartphone, a gaming console, and/or other computing platforms.

Server(s) 304 may be configured by machine-readable instructions 328. Client computing platform(s) 302 may be configured by machine-readable instructions 324. Machine-readable instructions 324 may include one or more instruction components. The instruction components may include computer program components. The instruction components may comprise data processing control component 326 and/or other instruction components. Machine-readable instructions 324 may include one or more instruction components. The instruction components may include computer program components. The instruction components may comprise data processing control component 326 and/or other instruction components.

Data processing control component 326 may be configured to perform one or more of the operations of method 100, one or more of the operations of method 200, and/or other operations. In some implementations, client computing platform(s) 302 may comprise a user interface. Data processing control component 326 may be configured to read user input to the user interface. The user input may indicate a request to use one or more machine learning models 310. For example, the user input may indicate a query, a reference to input data for machine learning model(s) 310. Data processing control component 326 may be configured to fetch pre-checklist(s) 312, post-checklist(s) 314, and/or other information. For example, pre-checklist(s) 312, post-checklist(s) 314, and/or other information may be fetched responsive to reading the user input.

Each pre-checklist 312 and each post-checklist 314 may be an instance of a checklist data structure. Each instance of a checklist data structure may comprise one or more of a phase identifier, data reference(s), library and/or tool identifier(s), a data format characterization, one or more attribute-associated functions, one or more pipeline functions, and/or other information. Data processing controlling component 326 may be configured to download some or all of the contents of each fetched checklist. The phase identifier may indicate whether the instance is configured for data pre-processing or post-processing. The one or more data references may comprise data itself, a dictionary, a uniform resource locator for a data source, and/or other information. Each library and/or tool identifier may comprise an identification of a non-public library, a public library, and/or a tool required for performance of the one or more attribute-associated function and/or the one or more pipeline functions. For example, the one or more data references comprise a dataset for loading into one or more machine learning models 310 prior to providing the input.

The data format characterization may comprise one or more attributes characterizing a data format for input to one or more machine learning models 310. The data format characterization may comprise one or more attributes characterizing a data format for a responsive to be presented to a user via the user interface. Each attribute of the data format characterization may be associated with at least one attribute-associated function. The one or more attribute-associated functions may be performed to convert raw input or raw output data to the format characterized by the data format characterization. For example, the at least one attribute-associated function associated with a first attribute may be performed to determine whether the format of data is in accordance with the first attribute. For example, the at least one attribute-associated function associated with a second attribute may be performed to conform data in accordance with the second attribute. For example, an attribute-associated function may be configured to determine whether one or more values are within a valid range. The one or more pipeline functions may be performed to perform data processing for providing input to a machine learning model 310 and/or for presenting as output via the user interface. For example, the one or more pipeline functions may be performed individually and/or in parallel.

For example, a pre-checklist 312 may be associated with a machine learning model 310 for generating inferences about an individual’s health based on that individual's fat ratio. Machine learning model 310 may be configured to receive height-weight pairs as input in the form of centimeters and kilograms (respectively). An exemplary pre-checklist 312 for such a machine learning model 310 comprises one or more of a user’s previous height-weight pairs. The previous height-weight pairs may be for loading machine learning model 310 prior to inference. Exemplary pre-checklist 312 may comprise a primary data format indicating the standard input is in the form of “[(cm, kg),(cm, kg),(cm, kg), … ]” (e.g., an array of centimeter-kilogram pairs). Exemplary pre-checklist 312 may comprise a reasonable height-weight pair scope or range. Exemplary pre-checklist 312 may comprise attribute functions associated with the primary data format. Such functions may include:
Check_pair: ensure input is a pair
Convert_m2cm: convert meter to centimeter for height
Convert_inch2cm: convert inch to centimeter for height
Convert_pound2kg: convert pound to kilogram for weight

Exemplary pre-checklist 312 may comprise pre-processing pipeline function as follows:
Stage 1: Coefficient_Height function to add coefficient to height input before AI inference.
Stage 2: Coefficient_Weight function to add coefficient to weight input before AI inference.
Stage 3: Shuffle_HW function to shuffle (height, weight) pair after adding coefficients with preset coefficient data for AI algorithm during inference.

Data processing control component 326 may be configured to read input data for one or more machine learning model(s) 310. By way of non-limiting example, the input data may have been provided by and/or identified by a user via the user interface. Data processing control component 326 may be configured to convert the input data in accordance with the data format characterization of pre-checklist(s) 312. By way of non-limiting example, converting the input data comprises determining whether the format of the input data matches and/or is in accordance with the data format characterization of pre-checklist(s) 312. Converting the input data may comprise performing the one or more attribute-associated functions.

For example, data processing controlling component 326 may be configured to categorize each user of machine learning model(s) 310 into an improper input category, an assumable input category, and/or a standard input category. Users categorized in the improper input category may have provided invalid input for using machine learning model(s) 310. Data processing controlling component 326 may be configured to present an indication to users in the improper input category to reformat or select new data via the user interface. Users categorized in the assumable input category may have provided input that does not match the standard form for input to machine learning model(s) 310 (e.g., the required input format for one or more machine learning models 310) but data processing controlling component 326 is configured to convert into the standard form. Users categorized in the standard input category may have provided input that matches the standard form.

Data processing control component 326 may be configured to perform the one or more pipeline functions of pre-checklist(s) 312. In some implementations, pre-processed input data may be generated by virtue of data processing control component 326 performing the one or more attribute-associated functions and/or the one or more pipeline functions. Data processing control component 326 may be configured to transmit the pre-processed input data to server(s) 304. For example, the pre-processed input data may be transmitted via network 334.

Server(s) 304 may be configured to receive the pre-processed input data. Server(s) 304 may be configured to provide the pre-processed input data to machine learning model(s) 310. Server(s) 304 may be configured to read output data generated by machine learning model(s) 310. Server(s) 304 may be configured to transmit the output data to client computing platform(s) 302. The output data may be transmitted via network 334.

Data processing control component 326 may be configured to receive and/or read the output data. Data processing control component 326 may be configured to convert the output data in accordance with the data format characterization of post-checklist(s) 314. By way of non-limiting example, converting the output data comprises determining whether the format of the output data matches and/or is in accordance with the data format characterization of post-checklist(s) 314. Converting the output data may comprise performing the one or more attribute-associated functions.

Data processing control component 326 may be configured to perform the one or more pipeline functions of pre-checklist(s) 312. In some implementations, post-processed output data may be generated by data processing control component 326 performing the one or more attribute-associated functions and/or the one or more pipeline functions. Data processing control component 326 may be configured to present the post-processed output data via the user interface.

Data processing control component 326 may be configured to determine a performance metric characterizing the efficiency of client computing platform(s) 302 and a performance metric characterizing the efficiency of server(s) 304. For example, the performance metrics may be determined based on current efficiencies. Data processing control component 326 may be configured to compare the performance metric for client computing platform(s) 302 and the performance metric for server(s) 304. Data processing control component 326 may be configured to determine whether to perform one or more attribute-associated functions and/or one or more pipeline functions locally (e.g., on client computing platform(s) 302) or remotely (e.g., on server(s) 304). Said determination may be based on said comparison of the performance metric for client computing platform(s) 302 and the performing metric for server(s) 304. For example, one or more attribute-associated functions and/or one or more pipeline functions of pre-checklist(s) 312 are performed by server(s) 304 responsive to said determination. For example, one or more attribute-associated functions and/or one or more pipeline functions of post-checklist(s) 314 are performed by server(s) 304 responsive to said determination.

Server(s) 304, client computing platform(s) 302, and/or external resources 332 may be operatively linked via one or more electronic communication links. For example, such electronic communication links may be established, at least in part, via network 334. For example, network 334 may comprise the Internet and/or other networks. It will be appreciated that this is not intended to be limiting, and that the scope of this disclosure includes implementations in which server(s) 304, client computing platform(s) 302, and/or external resources 332 may be operatively linked via some other communication media.

External resources 332 may comprise sources of information outside of system 300, external entities participating with system 300, and/or other resources. For example, external resources 332 may store input data 316, output data generated by machine learning model(s) 310, information used for pre-processing data, information used for post-processing data, and/or other information. In some implementations, some or all of the functionality attributed herein to external resources 332 may be provided by resources included in system 300.

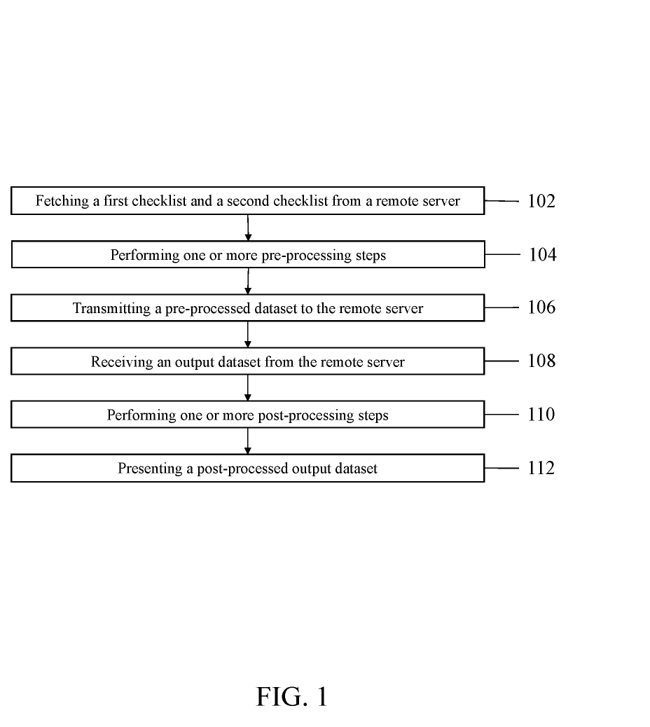

Server(s) 304 may comprise electronic storage 308, one or more processors 328, and/or other components. Server(s) 304 may include communication lines, or ports to enable the exchange of information with a network and/or other computing platforms. Illustration of server(s) 304 in FIG. 1 is not intended to be limiting. Server(s) 304 may include a plurality of hardware, software, and/or firmware components operating together to provide the functionality attributed herein to server(s) 304. For example, server(s) 304 may be implemented by a cloud of computing platforms operating together as server(s) 304.

Client computing platform(s) 302 may comprise electronic storage 306, one or more processors 322, and/or other components. Client computing platform(s) 302 may include communication lines, or ports to enable the exchange of information with a network and/or other computing platforms. Illustration of client computing platform(s) 302 in FIG. 1 is not intended to be limiting. Client computing platform(s) 302 may include a plurality of hardware, software, and/or firmware components operating together to provide the functionality attributed herein to client computing platform(s) 302. For example, client computing platform(s) 302 may be implemented by a cloud of computing platforms operating together as client computing platform(s) 302.

Electronic storage 306 and/or electronic storage 308 may comprise non-transitory storage media that electronically stores information. The electronic storage media of electronic storage 306 and/or electronic storage 308 may include one or both of system storage that is provided integrally (i.e., substantially non-removable) with client computing platform(s) 302, server(s) 304, and/or removable storage that is removably connectable to client computing platform(s) 302 and/or server(s) 304 via, for example, a port (e.g., a USB port, a firewire port, etc.) or a drive (e.g., a disk drive, etc.). Electronic storage 306 and/or electronic storage 308 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 306 and/or electronic storage 308 may include one or more virtual storage resources (e.g., cloud storage, a virtual private network, and/or other virtual storage resources). Electronic storage 306 and/or electronic storage 308 may store software algorithms, information determined by processor(s) 322, processor(s) 328, information received from server(s) 304, information received from client computing platform(s) 302, other information that enables client computing platform(s) 302 to function as described herein, and/or other information that enables server(s) 304 to function as described herein.

Processor(s) 322 and/or 328 may be configured to provide information processing capabilities in client computing platform(s) 302 and server(s) 304 (respectively). As such, processor(s) 322 and/or 328 may each comprise one or more of a digital processor, an analog processor, a digital circuit designed to process information, an analog circuit designed to process information, a state machine, and/or other mechanisms for electronically processing information. Although processor(s) 322 is shown in FIG. 1 as a single entity, this is for illustrative purposes only. In some implementations, processor(s) 322 may include a plurality of processing units. These processing units may be physically located within the same device, or processor(s) 322 may represent processing functionality of a plurality of devices operating in coordination. Processor(s) 322 may be configured to execute component 326, and/or other components. Although processor(s) 328 is shown in FIG. 1 as a single entity, this is for illustrative purposes only. In some implementations, processor(s) 328 may include a plurality of processing units. These processing units may be physically located within the same device, or processor(s) 328 may represent processing functionality of a plurality of devices operating in coordination.

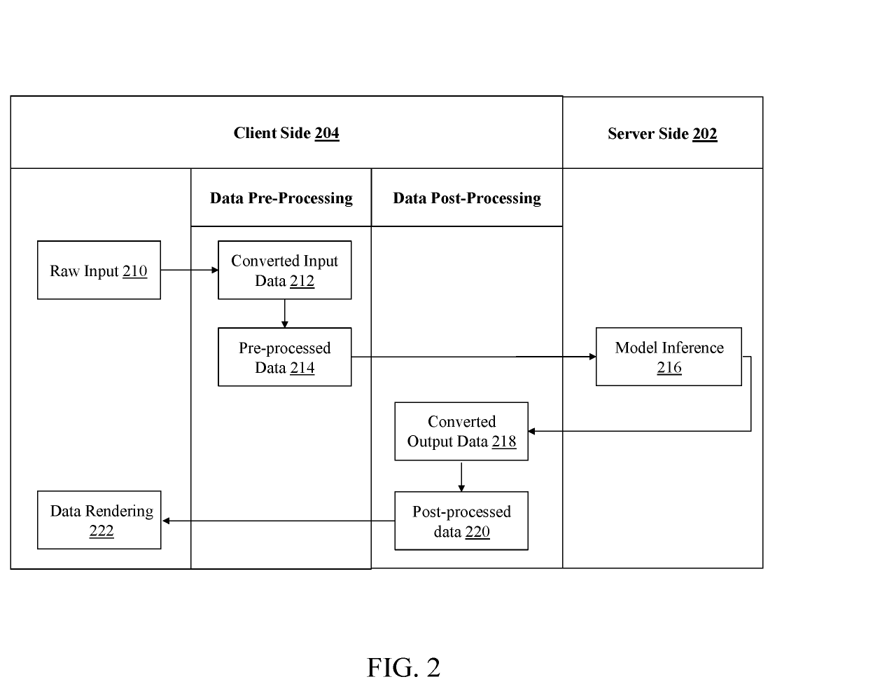

Referring now to FIG. 2, a flowchart illustrating an exemplary method 200 for distributed generation of inferences using hosted machine learning models is depicted in accordance with one or more embodiments of the present disclosure. The operations of method 200 presented below are intended to be illustrative. In some implementations, method 200 is accomplished with one or more additional operations not described and/or without one or more of the operations discussed. The operations of method 200 may be performed in another order. Additionally, the order in which the operations of method 200 are illustrated in FIG. 2 and described below is not intended to be limiting.

In some implementations, method 200 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 200.

Method 200 may comprise reading raw input 210. Method 200 may comprise converting the format of raw input 210 to generate converted input data 212. By way of non-limiting example, converted input data 212 has a predefined format. Converting the format of raw input 210 may comprise performing one or more attribute-associated functions. In some implementations, raw input 210 may be converted responsive to determining the format of raw input 210 does not match the predefined format.

In some implementations, operation 212 comprises determining the format of raw input 210 matches the predefined data format. Operation 214 may comprise pre-processing raw input 210 or converted input data 212 to generate pre-processed data 214. Raw input 210 may be pre-processed responsive to determining the format of raw input 210 matches the predefined format. Pre-processing raw input 210 or converted input data 212 may comprise performing one or more pipeline functions.

Method 200 may comprise transmitting pre-processed data 214 to a server 202 to be processed by at least one machine learning model. Server 202 may be configured to generate model inference 216. For example, model inference 216 is generated by the at least one machine learning model. Server 202 may be configured to transmit model inference 220 to client 204. Method 200 may comprise converting the format of model inference 216 to generate converted output data 218. By way of non-limiting example, converted output data 218 has a predefined format. Converting the format of model inference 216 may comprise performing one or more attribute-associated functions. In some implementations, model inference 216 may be converted responsive to determining the format of raw input 210 does not match the predefined format.

In some implementations, operation 212 comprises determining the format of raw input 210 matches the predefined data format. Operation 214 may comprise post-processing model inference 216 or converted output data 218 to generate post-processed data 220. Model inference 216 may be post-processed responsive to determining the format of model inference 216 matches the predefined format. Post-processing model inference 216 or converted output data 218 may comprise performing one or more pipeline functions. Method 200 may comprise generating data rendering 222. Data rendering 222 may be presented via a user interface. Data rendering 222 may depict post-processed data 220.

Referring now to FIG. 1, a flowchart illustrating an exemplary method 100 for distributed generation of inferences using hosted machine learning models is depicted in accordance with one or more embodiments of the present disclosure. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise fetching a first checklist for pre-processing input data for the machine learning model and a second checklist for post-processing output data from the machine learning model. For example, each of the first and second checklists may comprise and/or be an instance of a checklist data structure. The first checklist may comprise an indication of a pre-processing phase, at least one required input data format attribute, at least one attribute-associated function, at least one pre-processing pipeline function, and/or other information. Each input data format attribute may characterize a required data format for input to the machine learning model. The second checklist may comprise an indication of a post-processing phase, at least one required output data format attribute, at least one input attribute-associated function, at least one pre-processing pipeline function, and/or other information. For example, the one or more pre-processing steps comprise at least one input attribute-associated function and at least one pre-processing pipeline function. For example, the one or more post-processing steps comprises at least one input attribute-associated function and at least one pre-processing pipeline function. Each output data format attribute may characterize a required data format for output to be presented via the client computing platform. Operation 102 may be performed at a client from a remote server hosting a machine learning model. The first checklist may identify one or more pre-processing steps. The second checklist may comprise one or more post-processing steps. Operation 104 may comprise performing the one or more pre-processing steps on an input dataset to generate a pre-processed input dataset. Operation 104 may be performed at the client. The input dataset may comprise at least one input value. Performing the one or more pre-processing steps may comprise performing the one or more input attribute-associated functions, the one or more pre-processing pipeline functions, and/or another function.

In some implementations, method 100 comprises determining whether the format of the at least one input value matches a required input format. Said determination may comprise identifying at least one input data format attribute characterizing format of the at least one input value. Said identification may be performed at the client. Method 100 may comprise determining whether the at least one input data format attribute adheres to the at least one required input data format attribute. Determining whether the at least one input data format attribute adheres may comprise determining an input match score between the at least one input data format attribute and the at least one required input data format. Determining the at least one input data format attribute does not adhere may comprise determining the input match score is at most a format match threshold. By way of non-limiting example, operation 104 is performed responsive to determining the format of the at least one input value does not match the required input format. For example, the one or more input attribute-associated functions are performed responsively to determining the format of the at least one input value does not match the required input format. For example, the one or more pre-processing pipeline functions are performed responsive to determining the at least one input value matches the required input format, determining the at least one output value adheres to the at least one required output data format attribute, and/or responsive to performance of the at least one input attribute-associated function.

Operation 106 may comprise transmitting the pre-processed input dataset to be processed by the machine learning model. The pre-processed input dataset may be transmitted from the client to the remote server. Operation 108 may comprise receiving an output dataset. The output dataset may comprise at least one output value. The output dataset may be received at the client from the remote server.

Operation 110 may comprise performing the one or more post-processing steps on the output dataset to generate a post-processed output dataset. Operation 110 may be performed at the client. Performing the one or more post-processing steps may comprise performing the one or more output attribute-associated functions, the one or more post-processing pipeline functions, and/or another function.

In some implementations, method 100 comprises determining whether the format of the at least one output value matches a required output format. Said determination may comprise identifying at least one output data format attribute characterizing format of the at least one output value. Said identification may be performed at the client.

Method 100 may comprise determining whether the at least one output data format attribute adheres to the at least one required output data format attribute. Determining whether the at least one output data format attribute adheres may comprise determining an output match score between the at least one output data format attribute and the at least one required output data format. Determining the at least one output data format attribute does not adhere may comprise determining the output match score is at most a format match threshold. By way of non-limiting example, operation 110 is performed responsive to determining the format of the at least one output value does not match the required output format. For example, the one or more output attribute-associated functions are performed responsively to determining the format of the at least one output value does not match the required output format. For example, the one or more pre-processing pipeline functions are performed responsively to determining the at least one output value matches the required output format, determining the at least one output value adheres to the at least one required output data format attribute, and/or responsive to performance of the at least one output attribute-associated function. Operation 112 may comprise presenting the post-processed output dataset via a client computing platform at the client.

In some implementations, method 100 comprises determining a first performance efficiency of the server and a second performance efficiency of the client computing platform. Said determination of the first and second performance efficiencies may be at the client. Method 100 may comprise determining whether the second performance efficiency is preferable to the first performance efficiency. Said determination whether the first or second efficiency is preferable may be at the server. Responsive to determining the second performance efficiency is preferable, one or more of the operations of method 100 may be performed at the remote server. For example, one or more of operations 102, 104, 110, and/or other operations of method 100 may be performed at the remote server.

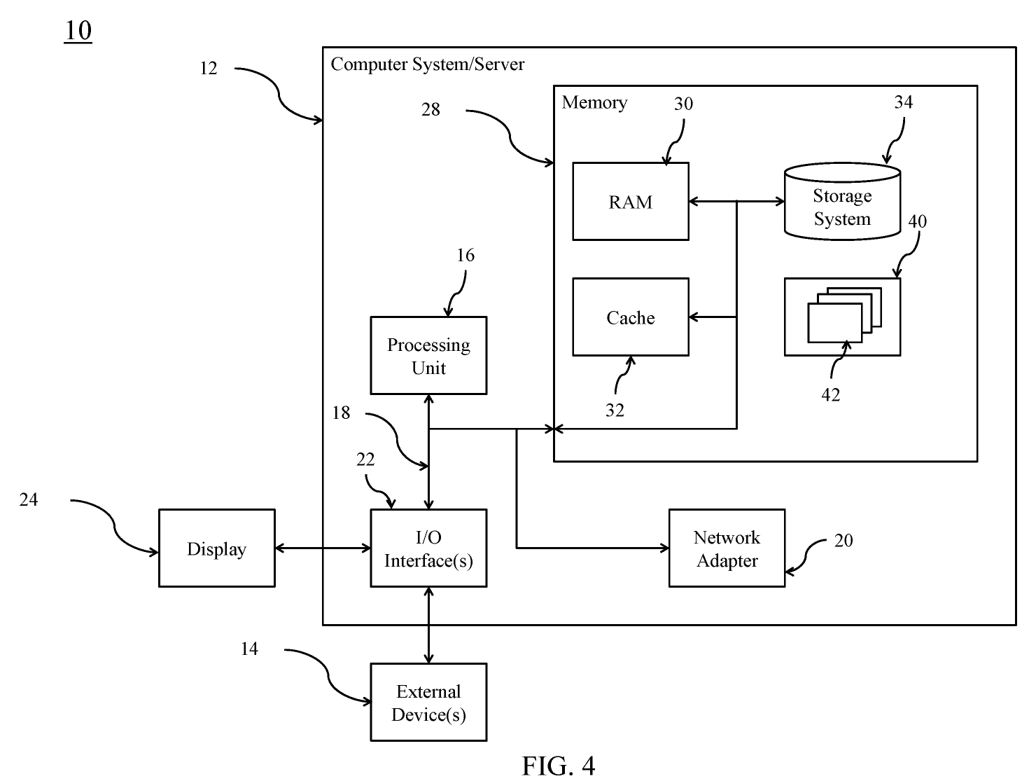

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a "floppy disk"), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of distributed generation of inferences using hosted machine learning models, the method comprising:
fetching, at a client from a remote server hosting a machine learning model, a first checklist for pre-processing input data for the machine learning model and a second checklist for post-processing output data from the machine learning model, wherein the first checklist identifies one or more pre-processing steps, wherein the second checklist comprises one or more post-processing steps;
performing the one or more pre-processing steps at the client on an input dataset to generate a pre-processed input dataset;
transmitting, from the client to the remote server, the pre-processed input dataset to be processed by the machine learning model;
receiving, at the client from the remote server, an output dataset;
performing the one or more post-processing steps at the client on the output dataset to generate a post-processed output dataset; and
presenting the post-processed output dataset via a client computing platform at the client.

2. The method of claim 1, wherein the first and second checklists are in the form of a checklist data structure, wherein each instance of a checklist comprises a processing phase indication, at least one required data format attribute characterizing a required data format, at least one attribute-associated function, and at least one pipeline function, wherein
the first checklist further comprises an indication of a pre-processing phase and at least one required input data format attribute characterizing a required data format for input to the machine learning model,
the one or more pre-processing steps comprises at least one input attribute-associated function and at least one pre-processing pipeline function,
the second checklist further comprises an indication of a post-processing phase and at least one required output data format attribute characterizing a required data format for output to be presented via the client computing platform, and
the one or more post-processing steps comprises at least one input attribute-associated function and at least one post-processing pipeline function.

3. The method of claim 2, wherein the input dataset comprises at least one input value, the method further comprising:
identifying, at the client, at least one input data format attribute characterizing format of the at least one input value; and
determining, at the client, the at least one input data format attribute does not adhere to the at least one required input data format attribute, and wherein
said performing of the one or more pre-processing steps comprises:
performing, on the at least one input value, the at least one attribute-associated function responsive to said determining the at least one input data format attribute does not adhere to the at least one required input data format attribute.

4. The method of claim 3, wherein said determining the at least one input data format attribute does not adhere to the at least one required input data format attribute comprises:
determining an input match score between the at least one input data format attribute and the at least one required input data format; and
determining the input match score is at most a format match threshold.

5. The method of claim 2, wherein the output dataset comprises at least one output value, the method further comprising:
identifying, at the client, at least one output data format attribute characterizing format of the at least one output value; and
determining, at the client, the at least one output data format attribute does not adhere to the at least one required output data format attribute, and wherein
said performing of the one or more post-processing steps comprises:
performing, on the at least one output value, the at least one attribute-associated function responsive to said determining the at least one output data format attribute does not adhere to the at least one required output data format attribute.

6. The method of claim 5, wherein said determining the at least one output data format attribute does not adhere to the at least one required output data format attribute comprises:
determining a output match score between the at least one output data format attribute and the at least one required output data format; and
determining the output match score is at most a format match threshold.

7. The method of claim 2, wherein said performing of the one or more pre-processing steps comprises performing the at least one pre-processing pipeline function, wherein said performing of the one or more post-processing steps comprises performing the at least one post-processing pipeline function.

8. The method of claim 7, wherein the input dataset comprises at least one input value, wherein the output dataset comprises at least one output value, the method further comprising:
identifying, at the client, at least one input data format attribute characterizing format of the at least one input value and at least one output data format attribute characterizing format of the at least one output value;
determining, at the client, the at least one input data format attribute adheres to the at least one required input data format attribute; and
determining, at the client, the at least one output data format attribute adheres to the at least one required output data format attribute, wherein
said performing of the one or more pre-processing pipeline functions is responsive to said determining the at least one input data format attribute adheres to the at least one required input data format attribute, and
said performing of the one or more post-processing pipeline functions is responsive to said determining the at least one output data format attribute adheres to the at least one required output data format attribute.

9. The method of claim 1, the method further comprising:
determining, at the client, a first performance efficiency of the server and a second performance efficiency of the client computing platform; and
determining, at the client, the second performance efficiency is preferable to the first performance efficiency, and wherein
said performing of the one or more pre-processing steps at the client and said performing of the one or more post-processing steps at the client is responsive to said determining the second performance efficiency is preferable.

10. A computer program product comprising:
one or more computer-readable storage media; and
program instructions stored on the one or more computer-readable storage media to perform operations comprising:
fetching, at a client from a remote server hosting a machine learning model, a first checklist for pre-processing input data for the machine learning model and a second checklist for post-processing output data from the machine learning model, wherein the first checklist identifies one or more pre-processing steps, wherein the second checklist comprises one or more post-processing steps;
performing the one or more pre-processing steps at the client on an input dataset to generate a pre-processed input dataset;
transmitting, from the client to the remote server, the pre-processed input dataset to be processed by the machine learning model;
receiving, at the client from the remote server, an output dataset;
performing the one or more post-processing steps at the client on the output dataset to generate a post-processed output dataset; and
presenting the post-processed output dataset via a client computing platform at the client.

11. The computer program product of claim 10, wherein the first and second checklists are in the form of a checklist data structure, wherein each instance of a checklist comprises a processing phase indication, at least one required data format attribute characterizing a required data format, at least one attribute-associated function, and at least one pipeline function, wherein
the first checklist further comprises an indication of a pre-processing phase and at least one required input data format attribute characterizing a required data format for input to the machine learning model,
the one or more pre-processing steps comprises at least one input attribute-associated function and at least one pre-processing pipeline function,
the second checklist further comprises an indication of a post-processing phase and at least one required output data format attribute characterizing a required data format for output to be presented via the client computing platform, and
the one or more post-processing steps comprises at least one input attribute-associated function and at least one post-processing pipeline function.

12. The computer program product of claim 11, wherein the input dataset comprises at least one input value, the operations further comprising:
identifying, at the client, at least one input data format attribute characterizing format of the at least one input value; and
determining, at the client, the at least one input data format attribute does not adhere to the at least one required input data format attribute, and wherein
said performing of the one or more pre-processing steps comprises:
performing, on the at least one input value, the at least one attribute-associated function responsive to said determining the at least one input data format attribute does not adhere to the at least one required input data format attribute.

13. The computer program product of claim 12, wherein said determining the at least one input data format attribute does not adhere to the at least one required input data format attribute comprises:
determining an input match score between the at least one input data format attribute and the at least one required input data format; and
determining the input match score is at most a format match threshold.

14. The computer program product of claim 11, wherein the output dataset comprises at least one output value, the operations further comprising:
identifying, at the client, at least one output data format attribute characterizing format of the at least one output value; and
determining, at the client, the at least one output data format attribute does not adhere to the at least one required output data format attribute, and wherein
said performing of the one or more post-processing steps comprises:
performing, on the at least one output value, the at least one attribute-associated function responsive to said determining the at least one output data format attribute does not adhere to the at least one required output data format attribute.

15. The computer program product of claim 14, wherein said determining the at least one output data format attribute does not adhere to the at least one required output data format attribute comprises:
determining a output match score between the at least one output data format attribute and the at least one required output data format; and
determining the output match score is at most a format match threshold.

16. The computer program product of claim 11, wherein said performing of the one or more pre-processing steps comprises performing the at least one pre-processing pipeline function, wherein said performing of the one or more post-processing steps comprises performing the at least one post-processing pipeline function.

17. The computer program product of claim 16, wherein the input dataset comprises at least one input value, wherein the output dataset comprises at least one output value, the operations further comprising:
identifying, at the client, at least one input data format attribute characterizing format of the at least one input value and at least one output data format attribute characterizing format of the at least one output value;
determining, at the client, the at least one input data format attribute adheres to the at least one required input data format attribute; and
determining, at the client, the at least one output data format attribute adheres to the at least one required output data format attribute, wherein
said performing of the one or more pre-processing pipeline functions is responsive to said determining the at least one input data format attribute adheres to the at least one required input data format attribute, and
said performing of the one or more post-processing pipeline functions is responsive to said determining the at least one output data format attribute adheres to the at least one required output data format attribute.

18. The computer program product of claim 10, the operations further comprising:
determining, at the client, a first performance efficiency of the server and a second performance efficiency of the client computing platform; and
determining, at the client, the second performance efficiency is preferable to the first performance efficiency, and wherein
said performing of the one or more pre-processing steps at the client and said performing of the one or more post-processing steps at the client is responsive to said determining the second performance efficiency is preferable.

19. A computer system comprising:
a processor set;
one or more computer-readable storage media; and
program instructions stored on the one or more computer-readable storage media to perform operations comprising:
fetching, at a client from a remote server hosting a machine learning model, a first checklist for pre-processing input data for the machine learning model and a second checklist for post-processing output data from the machine learning model, wherein the first checklist identifies one or more pre-processing steps, wherein the second checklist comprises one or more post-processing steps;
performing the one or more pre-processing steps at the client on an input dataset to generate a pre-processed input dataset;
transmitting, from the client to the remote server, the pre-processed input dataset to be processed by the machine learning model;
receiving, at the client from the remote server, an output dataset;
performing the one or more post-processing steps at the client on the output dataset to generate a post-processed output dataset; and
presenting the post-processed output dataset via a client computing platform at the client.

20. The computer system of claim 19, wherein the first and second checklists are in the form of a checklist data structure, wherein each instance of a checklist comprises a processing phase indication, at least one required data format attribute characterizing a required data format, at least one attribute-associated function, and at least one pipeline function, wherein
the first checklist further comprises an indication of a pre-processing phase and at least one required input data format attribute characterizing a required data format for input to the machine learning model,
the one or more pre-processing steps comprises at least one input attribute-associated function and at least one pre-processing pipeline function,
the second checklist further comprises an indication of a post-processing phase and at least one required output data format attribute characterizing a required data format for output to be presented via the client computing platform, and
the one or more post-processing steps comprises at least one input attribute-associated function and at least one post-processing pipeline function.
